(19) United States
(12) Patent Application Publication
(10) Pub. No.: US 2008/0312981 A1
(43) Pub. Date: Dec. 18, 2008

(54) Automated Identification of Competitors

(75) Inventors: Christopher A. Marlett, Los Angeles, CA (US); David Byrne, Santa Monica, CA (US)

Correspondence Address: MCDERMOTT WILL & EMERY LLP, 2049 CENTURY PARK EAST, 38th Floor, LOS ANGELES, CA, 90067-3208, US

(73) Assignee: MDB Capital Group, LLC

(21) Appl. No.: 11/762,668

(22) Filed: Jun. 13, 2007

(51) Int. Cl. G06Q 99/00

(52) U.S. Cl. 705/7

(57) ABSTRACT

A computer system may be configured with software that performs an automated process for identifying likely competitors of a specified entity. The process may include receiving information indicative of the identity of the specified entity. The process may include searching patent ownership data for patents and/or patent applications that are owned by the specified entity. The patent ownership data may be indicative of the identity of owners of patents and/or patent applications. The process may include searching patent citation data for patents and/or patent applications that are cited by and/or that cite to the patents and/or patent applications that are owned by the specified entity. The patent citation data may be indicative of the identity of patents and/or patent applications that cite to or are cited by other patents and/or patent applications. The process may include searching the patent ownership data for the owners of the cited and/or citing patents and/or patent applications and generating a report identifying the owners of the cited and/or citing patents and/or patent applications.

### CROSS-REFERENCE TO RELATED APPLICATION(S)

This application is related to the following applications, each of which has been filed on the same day as this application and is incorporated herein by reference: “Determining Intellectual Property Ownership Based On Non-Ownership Information,” Ser. No. ______, attorney docket no. 75750-015; “Automated Identification of Employment History,” Ser. No. ______, attorney docket no. 75750-017; and “Imputing Intellectual Property Owned by Subsidiaries During Automated Identification of Owned Intellectual Property,” Ser. No. ______, attorney docket no. 75750-018.

### BACKGROUND

1. Field

This application relates to identifying competitors of a particular entity.

2. Description of Related Art

Identifying competitors of a particular entity is a common task. This information may be needed by companies in the marketplace, by investors or prospective investors, and/or by others.

Unfortunately, the tools and resources that are available for performing this task are limited. Trade journals may occasionally publish this information, but the information may be incomplete or not current. In some cases, the information may not be available from any source.

### SUMMARY

A computer system may be configured with software that performs an automated process for identifying likely competitors of a specified entity. The process may include receiving information indicative of the identity of the specified entity. The process may include searching patent ownership data for patents and/or patent applications that are owned by the specified entity. The patent ownership data may be indicative of the identity of owners of patents and/or patent applications. The process may include searching patent citation data for patents and/or patent applications that are cited by and/or that cite to the patents and/or patent applications that are owned by the specified entity. The patent citation data may be indicative of the identity of patents and/or patent applications that cite to or are cited by other patents and/or patent applications. The process may include searching the patent ownership data for the owners of the cited and/or citing patents and/or patent applications and generating a report identifying the owners of the cited and/or citing patents and/or patent applications.

The searching the patent citation data may include searching for patents and/or patent applications that are cited by the patents and/or patent applications that are owned by the specified entity.

The searching the patent citation data may include searching for patents and/or patent applications that cite to the patents and/or patent applications that are owned by the specified entity.

The patent citation data may include issued patents and the searching for cited and/or citing patents and/or patent applications may include searching the References Cited section of the issued patents.

The patent citation data may include Information Disclosure Statements and the searching for cited and/or citing patents and/or patent applications may include searching the Information Disclosure Statements.

The patent citation data may include the specifications of patents and/or patent applications and the searching for cited and/or citing patents and/or patent applications may include searching the specifications of the patents and/or patent applications.

The report may indicate in some way that the owners of the cited and/or citing patents and/or patent applications are likely competitors of the specified entity.

The report may provide information relating to the number of cited and/or citing patents and/or patent applications that are owned by each owner. The information relating to the numbers may include presenting the owners in a sequence that is based on the numbers and/or information indicative of the relative differences between the numbers.

The report may exclude owners that own less than a threshold number of the cited and/or citing patents and/or patent applications.

The report may exclude owners that own less of the cited and/or citing patents and/or patent applications than other owners.

The searching the patent ownership data for patents and/or patent applications that are owned by the specified entity may include searching the patent ownership data for patents and/or patent applications that are owned by subsidiaries of the specified company.

The searching patent ownership data may include searching for inexact matches to the specified entity.

The searching patent ownership data may include searching for alternate names for the specified entity.

The information indicative of the specified entity may be the ticker symbol of the specified entity and an alternate name for at least one of the various entities may include the ticker symbol of the entity.

The patent ownership data may include patents and/or patent applications.

The patent ownership data may include assignment records for patents and/or patent applications.

The patents and/or patent applications that are owned by the specified entity may exclude patents and/or patent applications that are indicated in the patents and/or published applications as being owned by the specified entity, but that are indicated in the assignment records as no longer being owned by the specified entity.

The owner of a cited and/or citing patent and/or patent application may be designated as the owner indicated in the assignment records when different from the owner designated in the patents and/or patent applications.

The report may identify owners of the cited and/or citing patents and/or patent applications that have alternate names as the same owner.

The report may identify misspelled versions of owners of the cited and/or citing patents and/or patent applications as the same owner.

A computer system may be configured with software that performs an automated process for identifying likely competitors of a specified entity. The process may include generating a report identifying the owners of patents and/or patent applications that cite to and/or are cited by patents and/or patent applications that are owned by the specified entity.

Computer-readable media may contain computer-readable instructions that perform an automated process for identifying likely competitors of a specified entity. The process may include generating a report identifying the owners of patents and/or patent applications that cite to and/or are cited by patents and/or patent applications that are owned by the specified entity.

An automated process may identify likely competitors of a specified entity. The process may include generating a report identifying the owners of patents and/or patent applications that cite to and/or are cited by patents and/or patent applications that are owned by the specified entity.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings disclose illustrative embodiments. They do not set forth all embodiments. Other embodiments may be used in addition or instead. Details that may be apparent or unnecessary may be omitted to save space or for more effective illustration. When the same numeral appears in different drawings, it is intended to refer to the same or like components or steps.

FIG. 1 illustrates a computer system configured with software that performs an automated process for identifying intellectual property owned and likely to be owned by a specified entity, for identifying likely competitors of a specified entity, and for identifying the likely employment history of a specified individual.

FIG. 2 illustrates indirect relationships between a parent and its indirect subsidiaries that may exist in parent/subsidiary data, such as the parent/subsidiary data illustrated in FIG. 1.

FIG. 3 illustrates direct relationships between a parent and its indirect subsidiaries that may exist in parent/subsidiary data, such as the parent/subsidiary data illustrated in FIG. 1.

FIG. 4 illustrates variations in the name of a company that may exist in parent/subsidiary data, such as the parent/subsidiary data illustrated in FIG. 1.

FIG. 5 illustrates various types of data that may be part of intellectual property ownership data, such as the intellectual property ownership data illustrated in FIG. 1.

FIG. 6 illustrates various types of data that may be part of intellectual property characteristics data, such as the intellectual property characteristics data illustrated in FIG. 1.

FIG. 7 lists various fields of information that may be part of intellectual property characteristics data, such as the intellectual property characteristics data illustrated in FIG. 6.

FIG. 8 illustrates various types of data that may be part of patent citation data, such as the patent citation data illustrated in FIG. 1.

FIG. 9 illustrates various types of data that may be part of patent inventor data, such as the patent inventor data illustrated in FIG. 1.

FIG. 10 illustrates a process for identifying intellectual property owned by a specified company.

FIG. 11 illustrates a report identifying intellectual property owned by a specified company and by each of its subsidiaries.

FIG. 12 illustrates a process for identifying intellectual property likely to be owned by a specified entity.

FIG. 13 illustrates various types of characteristics that may be identified in the intellectual property that is owned by a specified entity.

FIG. 14 illustrates a report identifying intellectual property likely to be owned by a specified entity.

FIG. 15 illustrates a process for identifying likely competitors of a specified entity.

FIG. 16 illustrates a report identifying likely competitors of a specified entity.

FIG. 17 illustrates a process for identifying at least portions of the likely employment history of a specified individual.

FIG. 18 illustrates a report identifying at least portions of the likely employment history of a specified individual.

### DETAILED DESCRIPTION OF ILLUSTRATIVE EMBODIMENTS

Illustrative embodiments are now discussed. Other embodiments may be used in addition or instead. Details that may be apparent or unnecessary may be omitted to save space or for a more effective presentation.

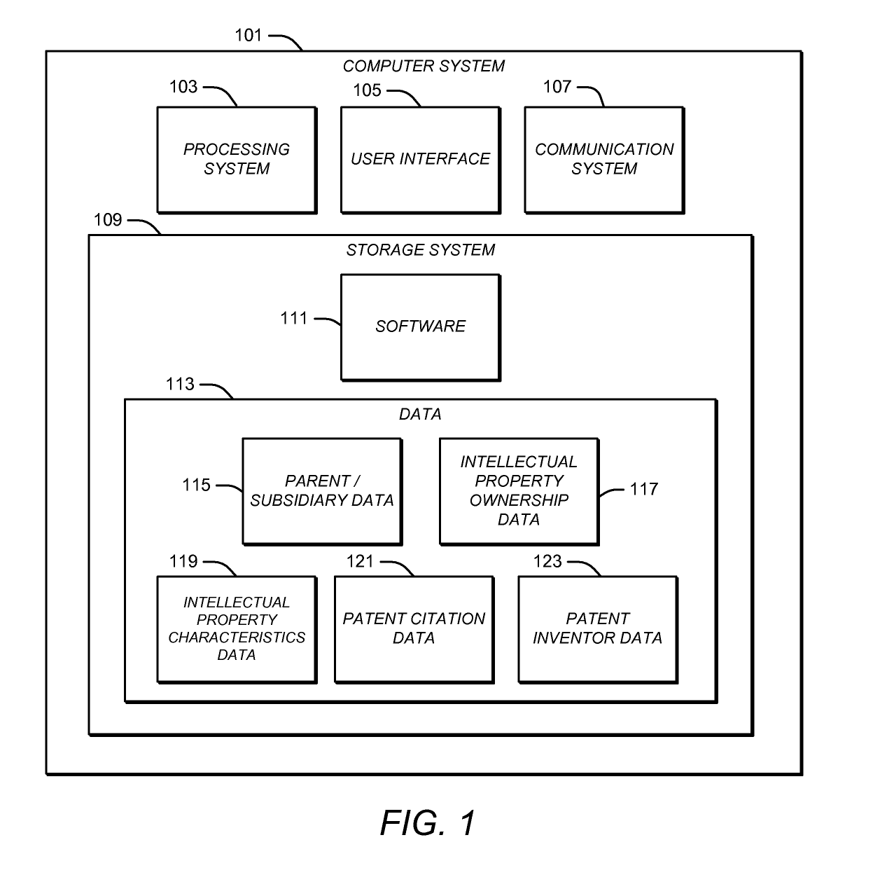

FIG. 1 illustrates a computer system 101 configured with software 111 that may perform an automated process for identifying intellectual property owned and likely to be owned by a specified entity, for identifying likely competitors of the specified entity, and for identifying the likely employment history of a specified entity. As illustrated in FIG. 1, the computer system 101 may include a processing system 103, a user interface 105, a communication system 107, and a storage system 109. The storage system 109 may store the software 111 and data 113. The data 113 may include parent/subsidiary data 115, intellectual property ownership data 117, intellectual property characteristics data 119, patent citation data 121, and patent inventor data 123.

The processing system 103 and the software 111 may be configured to perform one, several or all of the processes that are described herein, as well as others. They may be configured to perform one, some, or all of the steps of these processes in an automated fashion, without the need for human intervention.

The processing system 103 may include any number of processors. They may all be at a single location or distributed across several locations.

The user interface 105 may be configured to communicate with one or more users of the computer system 101. The user interface 105 may include one or more keyboards, displays, mice, touch screens, loud speakers, headphones, printers, and/or any other type of input or output device. The user interface 105 may itself consist of or include a computer system.

The communication system 107 may be configured to facilitate communication between the various components of the computer system 101, such as between the processing system 103, the user interface 105, and/or the storage system 109. The communication system 107 may include localized communication sub-systems, such as busses. It may include local area networks, wide area networks, and/or the Internet.

In one configuration, numerous users may communicate with one or more servers over the Internet through their own user interfaces, such as through client computers, all of which may collectively be part of the computer system 101. In another configuration, the computer system 101 may be entirely limited to a single, stand-alone computer with only a single user interface.

The storage system 109 may include any type or types of storage devices, such as hard disk drives, RAMs, ROMs, CD drives, DVD drives, tape drives, and/or flash drives. The various components of the storage system 109 may be at a single location or distributed across multiple locations. Communication between the various components of the storage system 109 may be facilitated by the communication system 107.

The software 111 and the data 113 may be stored on the storage system 109. Alternatively, all or portions of the software 111 and/or the data 113 may be stored remotely from the computer system 101 and accessed by the computer system 101. For example, portions of the data 113 may reside at public websites, such as the website of the United States Patent and Trademark Office and/or the website of the United States Copyright Office.

The parent/subsidiary data 115 may be indicative of the identity of subsidiaries of various companies. The parent/subsidiary data 115 may be gathered automatically or manually from any source, such as from public records. These records may include, for example, public filings made by companies with the Securities and Exchange Commission. Such filings may include an identification of the subsidiaries and/or parent entities of the filing company.

The parent/subsidiary data 115 may include information about subsidiaries of a particular company, without regard to the percentages of the subsidiaries that are owned by the particular company. In another embodiment, the parent/subsidiary data 115 may be limited to wholly-owned subsidiaries.

The parent/subsidiary data 115 may be in any form. For example, it may include relationships between parent entities and subsidiary entities.

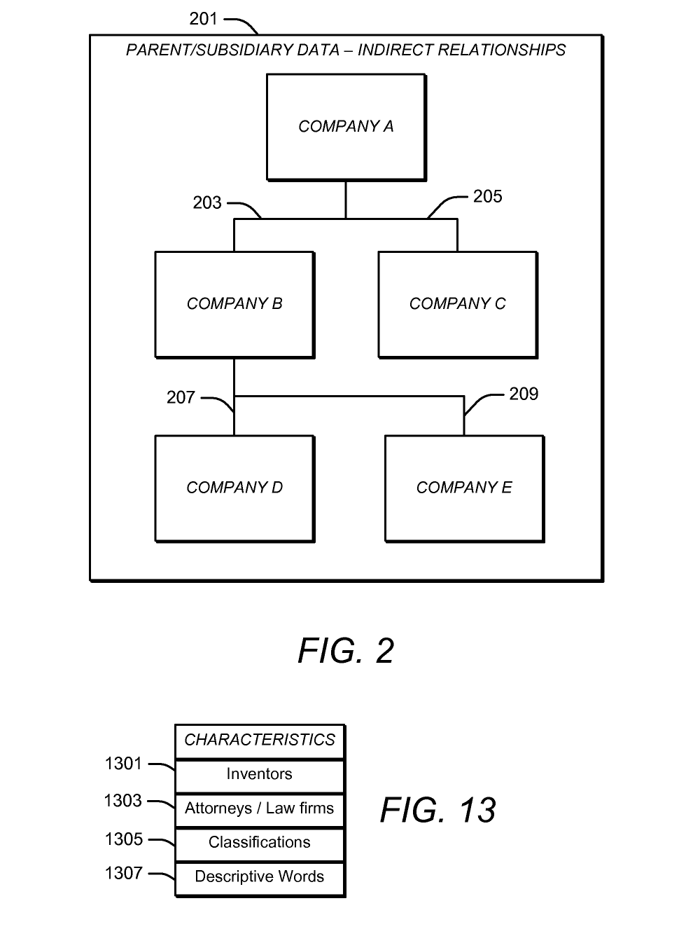

FIG. 2 illustrates indirect relationships between a parent and its indirect subsidiaries that may exist in parent/subsidiary data, such as the parent/subsidiary data 115 illustrated in FIG. 1. As illustrated in FIG. 2, parent/subsidiary data 201 may contain a relationship 203 between Company A and Company B that indicates that Company B is a subsidiary of Company A. It may similarly contain a relationship 205 that indicates that Company C is a subsidiary of Company A, and relationships 207 and 209 that indicate that Companies D and E, respectively, are subsidiaries of Company B. Companies D and E may be said to be direct subsidiaries of Company B and indirect subsidiaries of Company A.

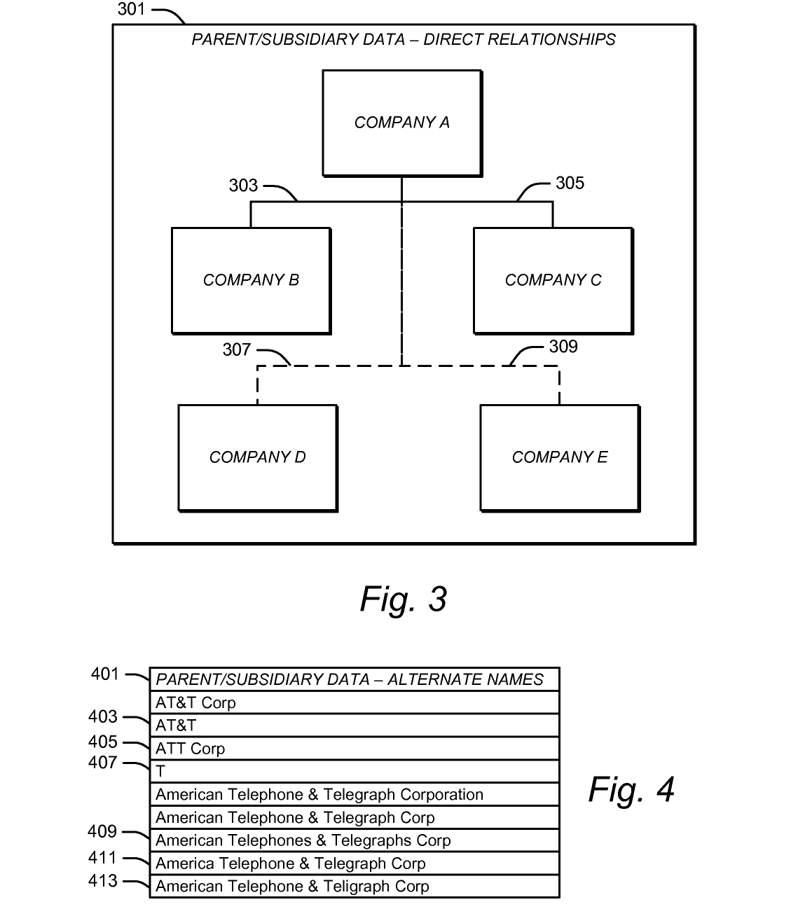

FIG. 3 illustrates direct relationships between a parent and its indirect subsidiaries that may exist in parent/subsidiary data, such as the parent/subsidiary data 115 illustrated in FIG. 1. As shown in FIG. 3, parent/subsidiary data 301 may contain relationships 303, 305, 307 and 309 between Company A and Companies B, C, D & E, respectively, that indicate that Companies B, C, D & E are subsidiaries of Company A. In fact, only Companies B and C may be direct subsidiaries of Company A, while Companies D and E may be indirect subsidiaries of Company A. The relationships 303, 305, 307 and 309 may be configured to indicate these differences, and the software 111 may be configured to understand these differences.

The parent/subsidiary data 115 may contain data and relationships in the configuration shown in FIGS. 2, 3, and/or in any other configuration.

FIG. 4 illustrates variations in the name of an entity that may exist in parent/subsidiary data, such as the parent/subsidiary data 115 illustrated in FIG. 1. As shown in FIG. 4, parent/subsidiary data 401 may include a table associated with one or more of the companies that are within the parent/subsidiary data 401 that lists alternate names for the company, including acronyms for the company, such as acronyms 403 and 405, a ticker symbol for the company, such as a ticker symbol 407, and/or misspellings of the company, such as misspellings 409, 411, and 413. Such a table of alternate names may be included for one or more of the parent companies in the parent/subsidiary data 401, and/or for one or more of the subsidiary companies. The various alternate names within each table may be acquired from a study of various records, including public records. They may in addition or instead be based on a projection of anticipated variations and/or based on any other approach.

Returning to FIG. 1, the intellectual property ownership data 117 may be indicative of the identity of intellectual property owned by various companies. The data may include relationships between the name of each company and the intellectual property that it owns.

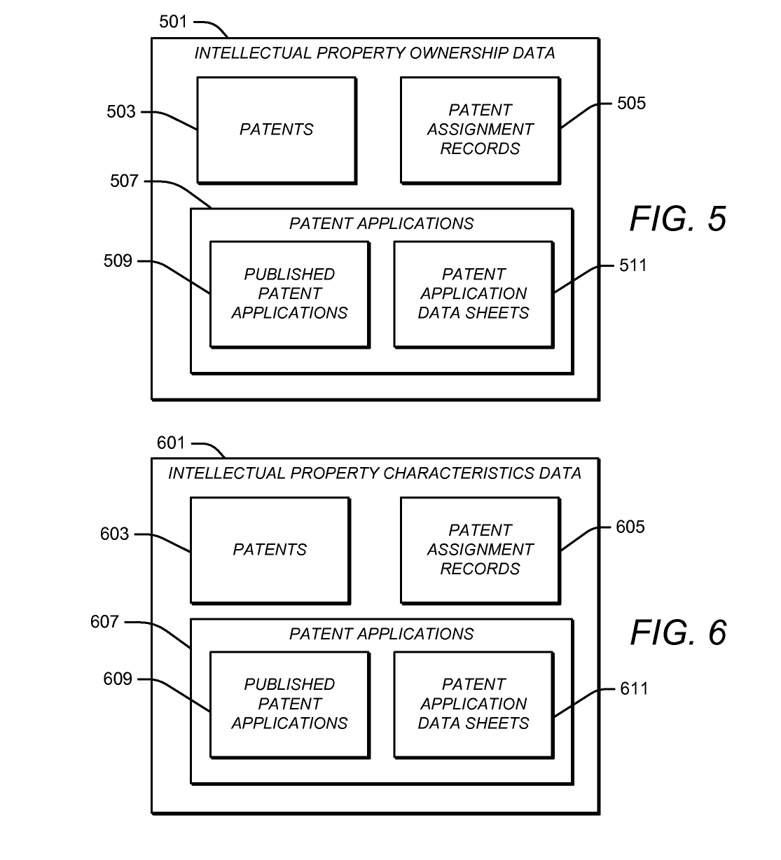

FIG. 5 illustrates various types of data that may be part of intellectual property ownership data, such as the intellectual property ownership data 117 illustrated in FIG. 1. As shown in FIG. 5, intellectual property ownership data 501 may include patents 503, patent assignment records 505, and/or patent applications 507. The patent assignment records 505 may include assignments and/or assignment indexing data. The patent applications 507 may include published patent applications 509 and/or patent application data sheets 511.

The intellectual property ownership data 501 may come from any source. For example, it may come from the United States Patent and Trademark Office and/or the United States Copyright Office. It may in addition or instead come from intellectual property bureaus in other countries and/or bureaus covering regions of countries. For example, the intellectual property ownership data 501 may include data relating to Patent Cooperation Treaty applications, European Patent Office applications, African Regional Intellectual Property Organization applications, as well as intellectual property data relating to individual countries outside of the United States.

Although only patent ownership data has thus-far been discussed, the intellectual property ownership data 501 may include data concerning other types of intellectual property, such as copyrights, trademarks, and/or trade secrets. Copyright data, for example, may come from the United States Copyright Office and/or copyright offices in other nations or regional areas. Similarly, trademark data may come from the United States Patent and Trademark Office, the Secretaries of the various states in the United States, and/or trademark offices and regional offices abroad.

The intellectual property ownership data 501 may be broken down into various searchable fields. For example, the fields may include an owner or assignee field, a title of invention field, a patent number field, a serial number field, a filing date field, an issue date field, and/or a name of the inventor(s) field.

Returning to FIG. 1, the intellectual property characteristics data 119 may be indicative of characteristics of various intellectual property. FIG. 6 illustrates various types of data that may be part intellectual property characteristics data, such as the intellectual property characteristics data 119 illustrated in FIG. 1. As shown in FIG. 6, intellectual property characteristics data 601 may include any of the types of data that were discussed above in connection with the intellectual property ownership data 501, such as patents 603, patent assignment records 605, and patent applications 607. The patent applications 607 may include published patent applications 609 and/or patent application data sheets 611.

As with the intellectual property ownership data 501, the intellectual property characteristics data 601 may include data relating to other types of intellectual property, may come from a variety of sources, and may concern a variety of countries.

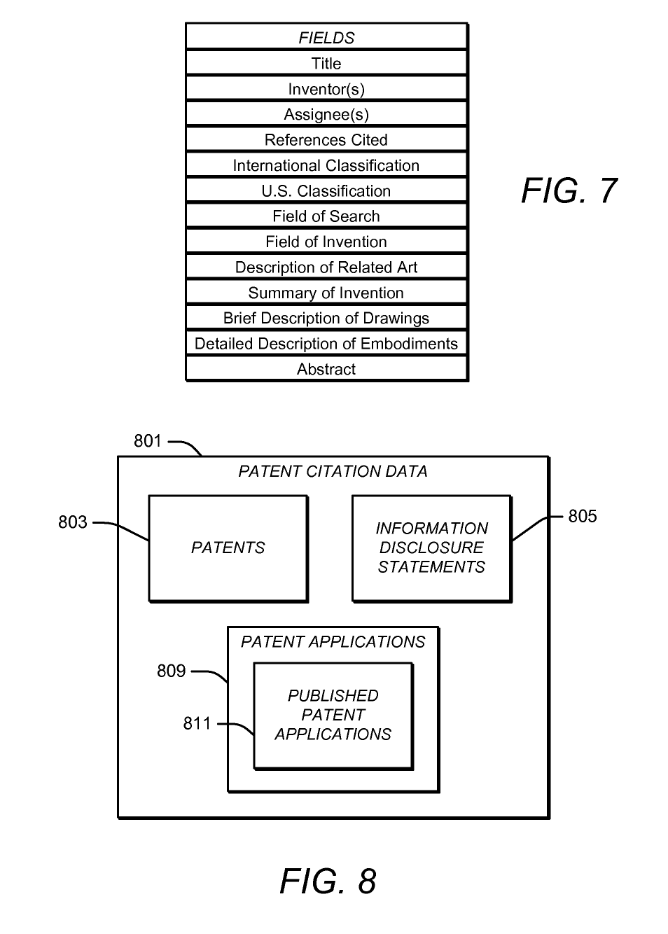

Also as with the intellectual property ownership data 501, the intellectual property characteristics data 601 may contain various searchable fields. FIG. 7 lists various fields of information that may be part of the intellectual property characteristics data 601. As shown in FIG. 7, the fields may include a Title, Inventor(s), Assignee(s), Reference Cited, International Classification, U.S. Classification, Field of Search, Field of Invention, Description of Related Art, Summary of Invention, Brief Description of Drawings, Detailed Description of Embodiments, and/or an Abstract. The intellectual property characteristics data 601 may include additional fields, may not include all of these fields, and/or may include similar fields under different designations.

Returning to FIG. 1, the patent citation data 121 may be indicative of the identity of patents and/or patent applications that cite to or are cited by other patents and/or patent applications.

FIG. 8 illustrates various types of data that may be part of patent citation data, such as the patent citation data 121 illustrated in FIG. 1. As shown in FIG. 8, patent citation data 801 may include patents 803, information disclosure statements 805, and patent applications 809. the patent applications 809 may include published patent applications 811. The patent citation data 801 may include some or all of the fields of information that are normally contained within the patents 803, the information disclosure statements 805, and/or the patent applications 809. As with the intellectual property ownership data 501, the patent citation data 801 may come from public records, such as records at the United States Patent and Trademark Office and/or records of other countries and/or regional bureaus.

Returning to FIG. 1, the patent inventor data 123 may be indicative of the inventors of patents and/or patent applications.

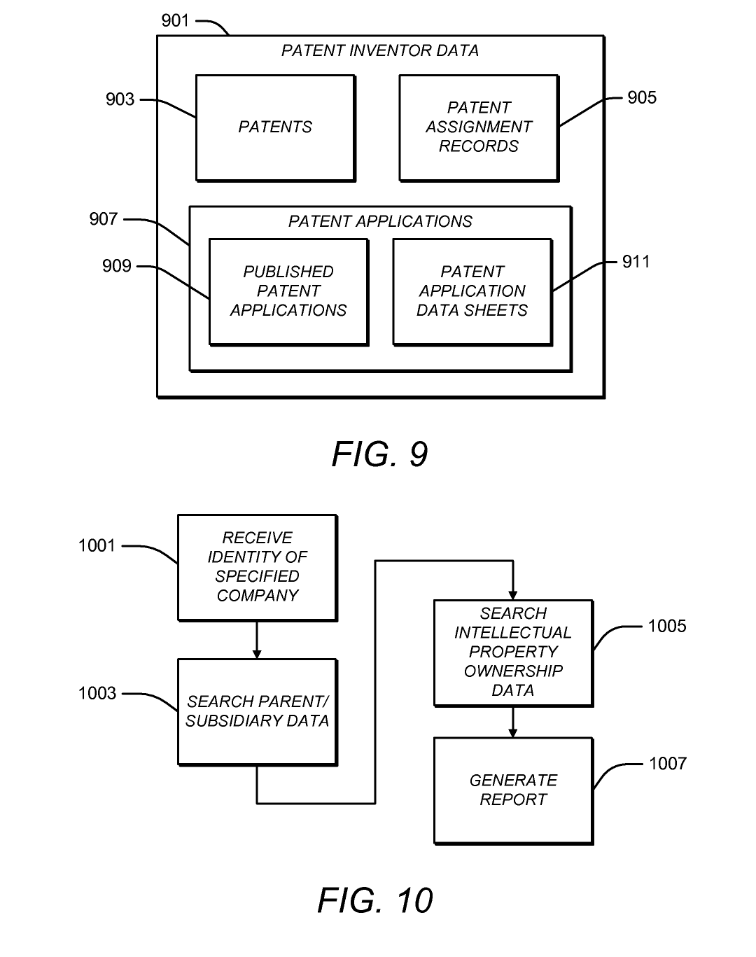

FIG. 9 illustrates various types of data that may be part of patent inventor data, such as the patent inventor data 123 illustrated in FIG. 1. As shown in FIG. 9, patent inventor data 901 may include any of the types of data that is in the intellectual property ownership data 501, such as patents 903, patent assignment records 905, and patent applications 907. The patent applications 907 may include published patent applications 909 and patent application data sheets 911. As with the intellectual property ownership data 501, the patent inventor data 901 may come from public records, such as records of the United States Patent and Trademark Office, and/or records of other countries and/or regions.

The intellectual property ownership data 117, the intellectual property characteristics data 119, the patent citation data 121, and the patent inventor data 123 have thus-far been illustrated as being separate. In fact, they may share common sets of data. For example, a single set of patent data may serve as the patents 503 in the intellectual property ownership data 501, the patents 603 in the intellectual property characteristics data 601, the patents 803 in the patent citation data 801, and/or the patents 903 in the patent inventor data 901. Different sets of patent data may instead be used. One or more common sets of data may similarly be used in connection with the data components of the intellectual property ownership data 117, the intellectual property characteristics data 119, the patent citation data 121, and/or the patent inventor data 123. Separate data sets may be used instead.

FIG. 10 illustrates a process for identifying intellectual property owned by a specified company. The process may use the computer system 101 illustrated in FIG. 1 and/or any other computer system. Similarly, the computer system illustrated in FIG. 1 may be used to identify intellectual property owned by a specified company using any other process.

The identity of a specified company whose intellectual property is to be identified may be received, as reflected by a Receive Identity of Specified Company step 1001. This information may be provided by a user through the user interface 105. In one embodiment, the information may be delivered by a user over the Internet to a web server.

The identity of the company may be specified in any way. For example, the identity may be specified by the user entering the precise legal name of the company. Alternate forms of that name may be used in addition or instead, such as acronyms, other names by which the company may be known, short hand versions of the legal name, misspelled versions of the company's name, and/or, when it has one, the ticker symbol of the company.

The parent/subsidiary data 115 may be searched for subsidiaries of the specified company, as reflected by a Search Parent/Subsidiary Data step 1003. The search may be conducted in any manner. Indirect subsidiaries of the specified company and/or subsidiaries that are not wholly owned by the specified company may be included or excluded from the search.

The search may consult a table of alternate names, such as the parent/subsidiary data 401 shown in FIG. 4. The search may look for subsidiaries of the specified entity under each of the alternate names in the parent/subsidiary data 115. The search may in addition or instead use fuzzy logic to look for inexact matches.

If the parent/subsidiary data 115 is organized in the fashion illustrated in FIG. 2, with only relationships between direct subsidiaries, the search may proceed on an iterative basis. The direct subsidiaries of the specified company and, in certain embodiments, of companies with the alternate names from the table and/or from fuzzy logic, may be located. For each located direct subsidiary and, in certain embodiments, companies with alternate names for the located subsidiary that may have been derived from an alternate name table and/or fuzzy logic, a search may be conducted for their subsidiaries. The process may repeat until all of the subsidiaries of the specified entity are identified, including both direct and indirect subsidiaries.

If the parent/subsidiary data 115 is organized in the fashion illustrated in FIG. 3 with relationships between a company and its direct and indirect subsidiaries, iterative searches may not need to be made.

The search may result in the generation and delivery of a list of entities that includes or consists of the specified entity, each of its direct and/or indirect subsidiaries, and alternate names for each of them taken from tables and/or fuzzy logic. In some embodiments, the list may include parents of the specified entity and, in certain cases, their alternate names, also from tables and/or fuzzy logic.

The results of searching the parent/subsidiary data 115 for subsidiaries of the specified company may be used in connection with a search of the intellectual property ownership data 117 for intellectual property that is owned by the specified company and by the subsidiaries of the specified company. This is reflected by a Search Intellectual Property Ownership Data step 1005. During this step, the intellectual property ownership data 117 may be searched for intellectual property that is owned by each of the companies that were identified during the Search Parent/Subsidiary Data step 1003. The results of the Search Intellectual Property Ownership Data step 1005 may include intellectual property owned by the specified company, its direct and indirect subsidiaries, and by alternate names of some of all of them.

Fuzzy logic and/or alternate name tables may be used during the Search Intellectual Property Ownership Data step 1005 to locate further intellectual property that may be owned by the specified company, so as to take into consideration the possibility of misspellings and other types of variations in the designation of the owners in intellectual property ownership data 117.

The Search Intellectual Property Ownership Data step 1005 may be restricted to various fields of information within the intellectual property ownership data 117. In connection with patent ownership data, for example, such as the intellectual property ownership data 501 illustrated in FIG. 5, the Search Intellectual Property Ownership Data step 1005 may be limited to the assignee field of the patents 503, the patent assignment records 505, and the patent applications 507, including the published patent applications 509 and the patent application data sheets 511.

In some cases, the patents 503 and/or the patent applications 507 may indicate that certain intellectual property is owned by a company that is the subject of the Search Intellectual Property Ownership Data step 1005, but the patent assignment records 505 may indicate that this intellectual property is no longer owned by this company. Such intellectual property may be excluded from the results of the Search Intellectual Property Ownership Data step 1005. This may be done based on the assumption that the information in the assignment records 505 is more current than the information in the patents 503 and/or patent applications 507.

The computer system 101 may be configured to present to the user through the user interface 105 a list of the company names that resulted from the Search Parent/Subsidiary Data step 1003 and/or the fuzzy logic that was or may be used during the Search Intellectual Property Ownership Data step 1005. This may be done either before or after the Search Intellectual Property Ownership Data step 1005. The computer system 101 may be configured to afford the user an opportunity to add, delete, and/or modify any of these names and/or fuzzy logic before a search is made or to redo a search based on the changes that are made.

A report identifying the intellectual property owned by the specified company and by each of the subsidiaries of the specified company may be generated, as reflected by a Generate Report step 1007.

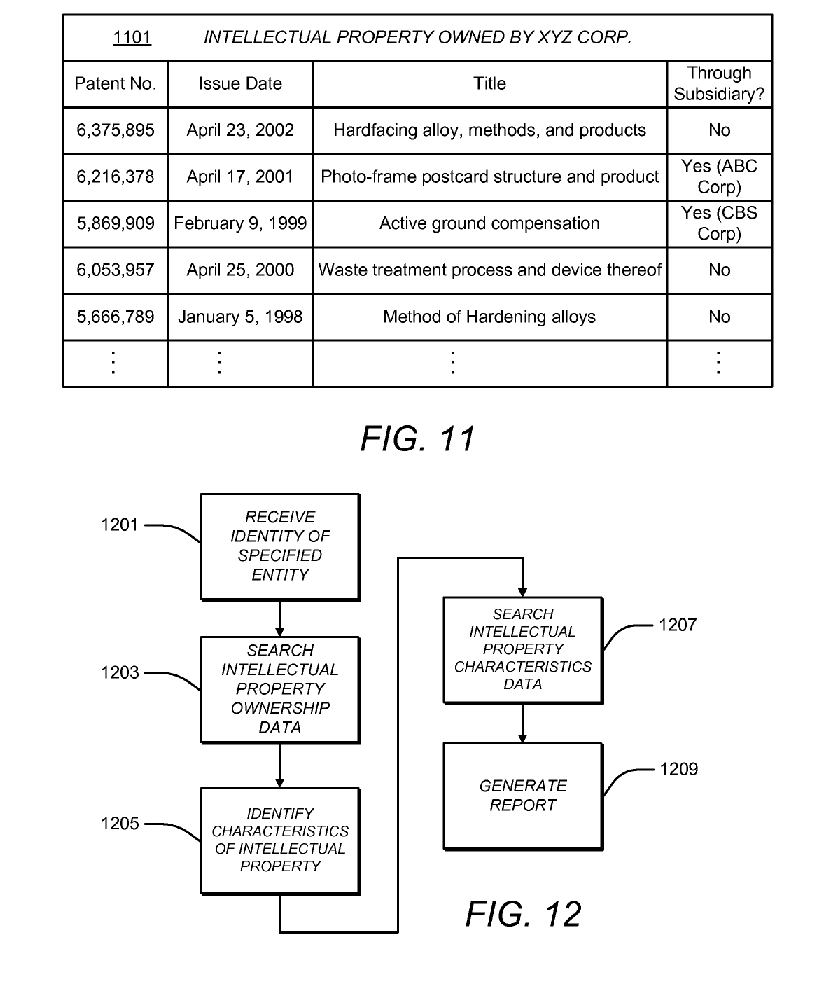

FIG. 11 illustrates a report identifying intellectual property owned by a specified company and by each of its subsidiaries. The report may be prepared by the process illustrated in FIG. 10, the computer system illustrated in FIG. 1, and/or by any other process and/or computer system. Similarly, the process illustrated in FIG. 10 and/or the computer system illustrated in FIG. 1 may be used to generate any other report identifying intellectual property owned by a specified company and by each of its subsidiaries.

For each patent, the report may include a patent number, issue date, title, and whether the intellectual is owned by the specified company directly or through a subsidiary, as illustrated in FIG. 11. If owned through a subsidiary, the name of the subsidiary may be provided. Although not shown I FIG. 11, the report may disclose whether the subsidiary is a direct or indirect subsidiary.

The report may include information describing the content of the report, such as a header 1101, that indicates in some way that the information in the report constitutes an identification of intellectual property owned by the specified company. Any language or symbols may be used to communicate this relationship.

Although only listing issued patents, the report may in addition or instead list patent applications. The report may or may not include patent applications that have issued or that never matured into a patent and that are now abandoned.

The report may in addition or instead list other types of intellectual property that is owned by the specified entity, such as trademarks, trademark applications, copyrights, and/or copyright applications.

FIG. 12 illustrates a process for identifying intellectual property likely to be owned by a specified entity. The process may use the computer system illustrated in FIG. 1 and/or any other type of computer system. Similarly, the computer system illustrated in FIG. 1 may be used to identify intellectual property likely to be owned by a specified entity using any other process.

As illustrated in FIG. 12, the identity of an entity whose intellectual property is to be identified may be specified, as reflected by a Receive Identity of Specified Entity step 1201. The procedures and variations relating to this step may be the same as those discussed above in connection with the Receive Identity of Specified Company step 1001. However, the entity that is identified in connection with the Receive Identity of Specified Entity step 1201 may be an individual, as well as a company.

Intellectual property ownership data may be searched for intellectual property that is owned by the specified entity, as reflected by a Search Intellectual Property Ownership Data step 1203. This step may proceed and be subject to the same variations as were discussed above in connection with the Search Intellectual Property Ownership Data step 1005. Subsidiaries of the specified entity may or may not be included.

The intellectual property that is searched during the Search Intellectual Property Ownership Data step 1203 may be of any type. For example, the intellectual property may include patents and/or patent applications.

Characteristics of the intellectual property that are identified as a result of the Search Intellectual Property Ownership Data step 1203 may be identified, as reflected by an Identify Characteristics of Intellectual Property step 1205.

FIG. 13 illustrates various types of characteristics that may be identified in the intellectual property that is owned by a specified entity. FIG. 13 focuses on characteristics of patents and/or patent applications. A comparable set of characteristics or a different set of characteristics, or a mixture of them, may be identified in connection with other types of intellectual property.

As reflected in FIG. 13, the characteristics that are identified may include a broad array of information from the patents and/or patent applications, including named inventors 1301, named attorneys/law firms 1303 that prosecuted the patent applications, identified classifications 1305 of the patents and/or patent applications, and/or descriptive words 1307 that are contained within the patents and/or patent applications. Other characteristics may be identified in addition or instead. One characteristic that may not be identified is the owner of the patents and/or patent applications.

The characteristics that are identified during the Identify Characteristics of Intellectual Property step 1205 may be limited to characteristics that have a certain threshold level of commonality between the intellectual property that is identified during the Search Intellectual Property Ownership Data step 1203. For example, the descriptive words 1307 may be limited to words that appear in a certain percentage of the uncovered intellectual property. The descriptive words 1307 may also be filtered to remove words that do not significantly differentiate between different types of inventions or, conversely, be limited to words that do particularly distinguish between different types of inventions. The Identify Characteristics of Intellectual Property step 1205 may also identify the degree to which a particular characteristic is found within the set of searched intellectual property.

The intellectual property characteristics data 119 may be searched for intellectual property that has one or more of the characteristics that were identified during the Identify Characteristics of Intellectual Property step 1205, as reflected in a Search Intellectual Property Characteristics Data step 1207. This search may exclude intellectual property that was identified during the Search Intellectual Property Ownership Data step 1203.

For example, the Search Intellectual Property Characteristics Data step 1207 may search for patents and/or patent applications that name one or more of the inventors that were identified during the Identify Characteristics of Intellectual Property step 1205. The search may in addition or instead search for patents and/or patent applications that name one or more of the attorneys/law firms that were identified during the Identify Characteristics of Intellectual Property step 1205. The search may in addition or instead search for patents and/or patent applications that are classified within one or more of the classifications that were identified during the Identify Characteristics of Intellectual Property step 1205. The search may in addition or instead search for patents and/or patent applications that contain one or more of the descriptive words that were identified during the Identify Characteristics of Intellectual Property step 1205. The search may not search for patents and/or patent applications that list the owner as the specified owner, as these were presumably previously identified during the Search Intellectual Property Ownership Data step 1203.

Rules may be established to limit the intellectual property that is identified during the Search Intellectual Property Characteristics Data step 1207. For example, a rule may require the intellectual property to contain a threshold level relating to the identified characteristics, such as a threshold number of the characteristics or a threshold quality in the match. For example, a rule may require a patent or patent application to contain a matching inventor and a matching attorney or law firm. A rule may specify various Boolean relationships between two or more of the identified characteristics that must be satisfied.

The Search Intellectual Property Characteristics Data step 1207 may employ fuzzy logic to make inexact matches between some or all of the characteristics, such as in connection with the names of the inventors, attorneys, law firms, and/or all or some of the descriptive words.

A report of the intellectual property that has been identified as a result of the Search Intellectual Property Characteristics Data step 1207 may be generated, as reflected by a Generate Report step 1209.

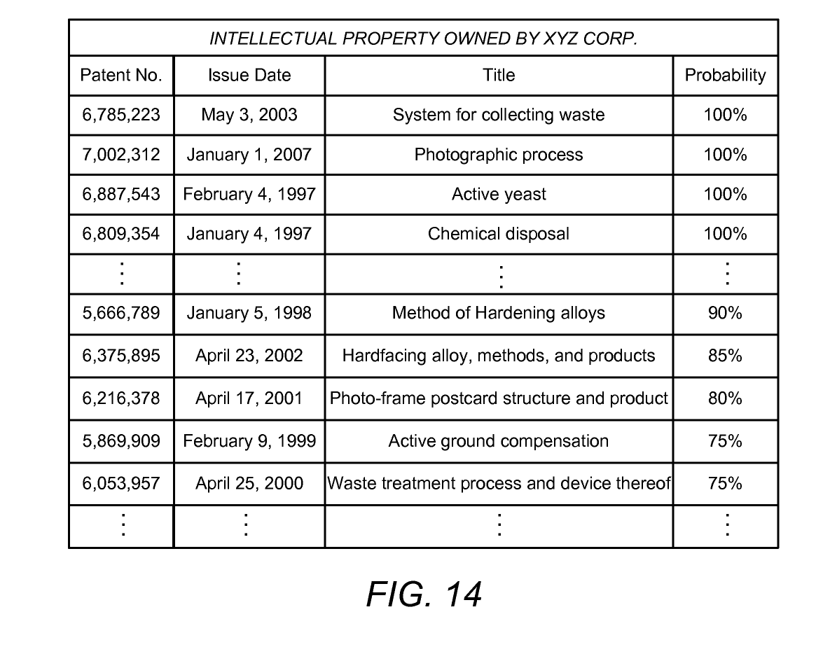

FIG. 14 illustrates a report identifying intellectual property likely to be owned by a specified entity. This report may be generated by the process illustrated in FIG. 12, the computer system illustrated in FIG. 1, and/or by any other process or computer system. Similarly, the process illustrated in FIG. 12 and/or the computer system illustrated in FIG. 1 may be used to generate any other type of report identifying intellectual property likely to be owned by a specified entity.

As illustrated in FIG. 14, the report may identify intellectual property that has one or more of the identified characteristics as intellectual property that is likely to be owned by the specified entity. The report may include a probability rating indicative of the likelihood of the intellectual property being owned by the specified entity. If the identified intellectual property resulted from the Search Intellectual Property Ownership Data step 1203, the intellectual property may be indicated as having a 100% probability of being owned by the specified entity. On the other hand, if the intellectual property resulted from the Search Intellectual Property Characteristics Data step 1207, the intellectual property may be indicated as having less than a 100% probability. The probability may be based on the degree to which the intellectual property has the identified characteristics and/or the nature of the identified characteristics.

The process illustrated in FIG. 12 may therefore search for intellectual property that is known to be owned by a specified entity. It may then extract characteristics from this intellectual property, search for other intellectual property with similar characteristics, and assume that such other intellectual property is also owned by the specified entity because it has these common characteristics.

The intellectual property that results from the Search Intellectual Property Characteristics Data step 1207 may be required to have a threshold level of the identified characteristics before it is included in the report. Rules, similar to those described above that may have been used during the search, may in addition or instead be used to govern which search results are included within the report.

The report illustrated in FIG. 14 may include intellectual property that is explicitly owned by the identified entity, that is intellectual property that resulted from the Search Intellectual Property Ownership Data step 1203. It may also include intellectual property that is implicitly owned by the identified entity, that is intellectual property that resulted from the Search Intellectual Property Characteristics Data step 1204. In another embodiment, the report may include only the implicitly owned intellectual property or only the explicitly owned intellectual property.

The report may rank the implicitly owned intellectual property by the likelihood that it is owned by the specified entity. It may do so by specifying a probability that it is owned by the specified entity or in any other way. The report may in addition or instead provide more specific information about the matching characteristics, such as an identification of which characteristics match and/or the degree to which they match.

In determining the likelihood that intellectual property is implicitly owned by the specified entity, the computer system 101 may consider the importance of the matching characteristics and/or the degree to which the intellectual property that is known to be owned by the specified entity contains the matching characteristics. Any other approach for assessing the likelihood of ownership may be used in addition or instead.

Although FIG. 14 illustrates only issued patents, patent applications and/or other types of intellectual property may be listed in addition or instead. The report may include different or additional types of information about the intellectual property. Ownership information about other types of intellectual property may be provided in addition or instead.

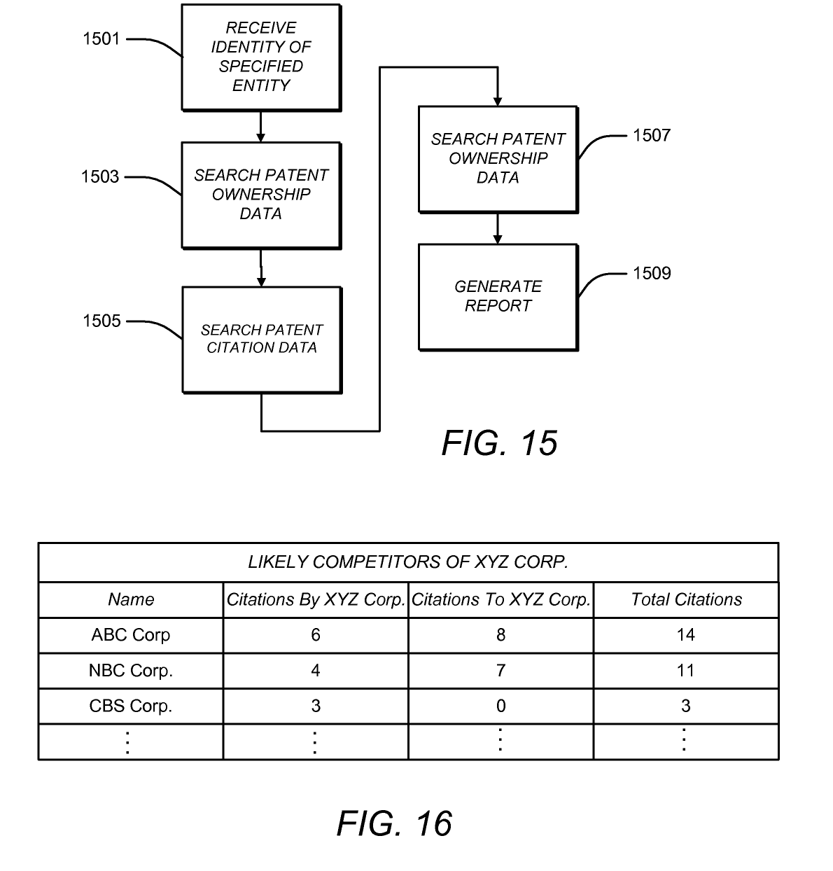

FIG. 15 illustrates a process for identifying likely competitors of a specified entity. The process illustrated in FIG. 15 may be performed using the computer system illustrated in FIG. 1 or any other type of computer system. Similarly, the computer system illustrated in FIG. 1 may be used to perform any other process for identifying likely competitors of a specified entity.

As illustrated in FIG. 15, the identity of an entity whose competitors are to be identified may be specified, as reflected by a Receive Identity of Specified Entity step 1501. The procedures and variations relating to this step may be the same as those discussed above in connection with the Receive Identity of Specified Entity step 1201. However, the entity that is specified may be an entity for which there is a desire to know its competitors.

A Search Patent Ownership Data step 1503 may be performed to identify patents and/or patent applications that are owned by the specified entity. It may be performed in accordance with any of the procedures and variations that were discussed above in connection with the Search Intellectual Property Ownership Data step 1005 and/or 1203, except that the Search Patent Ownership Data step 1503 may be limited to a search of patent ownership data, such as the data illustrated in FIG. 5. The Search Patent Ownership Data step 1503 may or may not include a search for patents and/or patent applications that are owned by subsidiaries of the specified entity, as well as by the specified entity.

As reflected by a Search Patent Citation Data step 1505, patent citation data, such as the patent citation data 121, may be searched for patents and/or patent applications that are cited by and/or that cite to the patents and/or patent applications that were determined to be owned by the specified entity during the Search Patent Ownership Data step 1503. During the Search Patent Citation Data step 1505, the patent citation data may be searched for patents that cite to the patents that are owned by the specified entity and/or for patents that are cited by the patents and/or patent applications that are owned by the specified entity.

The Search Patent Citation Data step 1505 may be performed by any means. When searching for patents and/or patent applications that are cited by the patents and/or patent applications that are owned by the specified entity, for example, the Search Patent Citation Data step 1505 may examine the “References Cited” section of the patents that are owned by the specified entity, the “Information Disclosure Statements” that were filed during the pursuit of the patents and/or patent applications that are owned by the specified entity, and/or in any or all of the textual sections within the patents and/or patent applications that are owned by the specified entity, such as in the “Background of Invention” and/or “Detailed Description of Illustrative Embodiments” sections.

Similarly, when the search is looking for patents and/or patent applications that cite to the patents and/or patent applications that are owned by the specified entity, the search may look for such citations in the “References Cited” section of other patents, in the “Information Disclosure Statements” that were filed in connection with other patent applications, and/or in any or all of the textual sections of such other patents and/or patent applications, such as in the “Background of Invention” and/or “Detailed Description of Illustrative Embodiments” sections.

The patent ownership data may again be searched, as reflected by a Search Patent Ownership Data step 1507. This time, however, the search may be for the owners of the intellectual property that was identified as a result of the Search Patent Citation Data step 1505. In other words, the Search Patent Ownership Data step 1507 may search for the owners of the patents and/or patent applications that are cited by or that cite to the patents and/or patent applications that are owned by the specified entity.

The Search Patent Ownership Data step 1507 may proceed in much the same way and be subject to the same variations as the Search Patent Ownership Data step 1503, except in the reverse fashion. This search may be configured to identify owners of specified intellectual property, not intellectual property owned by a specified entity. Nevertheless, the same corresponding procedures and variations may be implemented. For example, the owner of record as shown by the patent assignment records 505 may take precedent over the owner that may be reflected in the patents 503 and/or the patent applications 507. When this is done, this may reflect a judgment that a company should no longer be considered a competitor when it no longer owns a related patent and/or patent application.

A report may be prepared, as reflected by a Generate Report step 1509. The report may identify the owners that are identified during the Search Patent Ownership Data step 1507. These may be owners of patents and/or patent applications that cite to or are cited by patents and/or patent applications that are owned by the specified entity.

FIG. 16 illustrates a report identifying likely competitors of a specified entity. This report may be generated by the process illustrated in FIG. 15, by the computer system illustrated in FIG. 1, and/or by any other process or computer system. Similarly, the process illustrated in FIG. 15 and/or the computer system illustrated in FIG. 1 may generate any other type of report identifying likely competitors of a specified entity.

As shown in FIG. 16, the report may identify likely competitors of the specified entity. It may do so by describing the companies that own cited or citing patents and/or patent applications as likely competitors of the specified entity or with other words or symbols having similar meaning.

As reflected in FIG. 16, the report may disclose the number of patents and/or patent applications of a competitor that were cited by and/or that cite to the patents and/or patent applications that are owned by the specified entity. It may order the likely competitors that are identified in the report based on the number of their cited and/or citing patents and/or patent applications. Companies that fail to have a threshold number of cited and/or citing patents and/or patent applications may be excluded from the report. The threshold may be an absolute amount (e.g., less than five) or a relative amount (e.g., not one of the five most frequently cited companies).

The report illustrated in FIG. 16 may merge results for alternate names of a company, including acronyms, ticker symbols, and misspellings, by listing these under the name of a single company. It may similarly consolidate the number of search hits for each of these alternate names when formulating rankings and/or presenting counts of the hits.

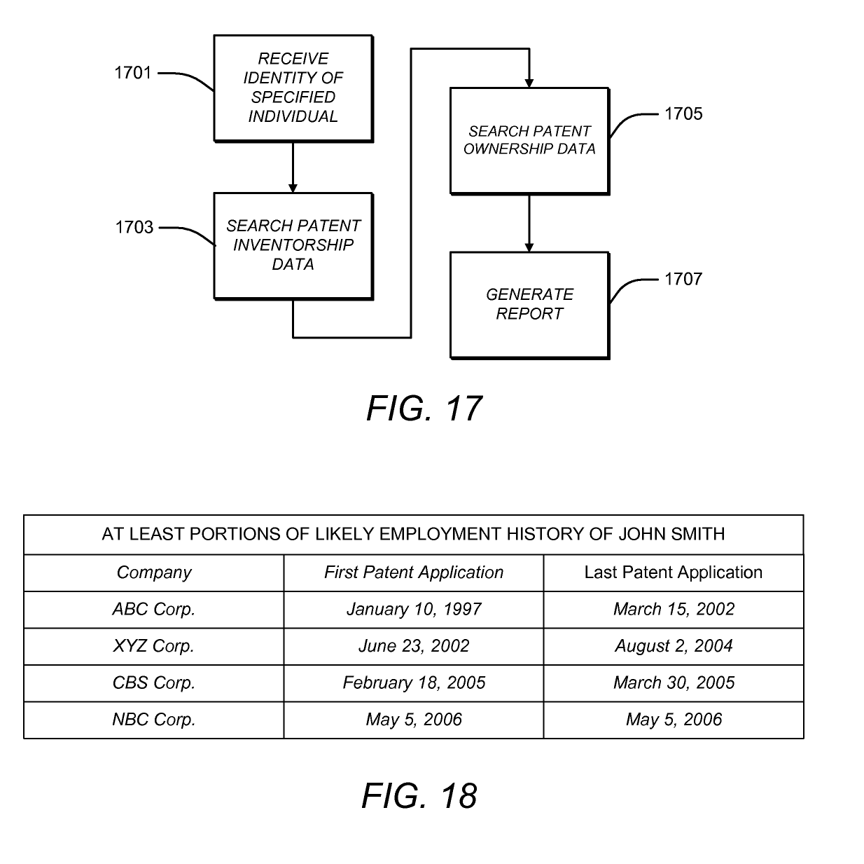

FIG. 17 illustrates a process for identify at least portions of the likely employment history of a specified individual. This process may be implemented by the computer system illustrated in FIG. 1 or by any other type of computer system. Similarly, the computer system illustrated in FIG. 1 may implement any other process for identifying at least portions of the likely employment history of a specified individual.

The identity of an individual whose employment history is desired may be specified, as illustrated by a Receive Identity of Specified Individual step 1701. This step may be performed just like the Receive Identity of Specified Company step 1001, except that the name of an individual whose employment history is desired may be specified instead.

The patent inventor data 123 may be searched, as reflected by a Search Patent Inventor Data step 1703. During this step, the patent inventor data 123 may be searched for patents and/or patent applications that list the specified individual as an inventor. Fuzzy logic may be used to facilitate a more complete identification of the patents and/or patent applications, notwithstanding minor variations in the name as set forth in the search query and/or the patent inventor data 123, such as misspellings, missing middle initials, and/or shorthand versions of the individual's name.

A search may be made of the patent ownership data 117, as reflected by a Search Patent Ownership Data step 1705. This step may seek to identify the owners of the patents and/or patent applications that list the specified individual as the inventor. This step may proceed and be subject to the same variations as were discussed above in connection with the Search Intellectual Property Ownership Data step 1005.

During this step, however, the search may be directed to the companies to whom the inventor transferred his or her interest, regardless of whether these companies still own the patents and/or patent applications. In some cases, for example, the assignee indicated on the face of a patent may not be the desired company. Transfers from one assignee to another can occur during the pursuit of a patent, and the identify of the assignee is often updated before the patent issues.

In order to identify owners at this level of granularity, it may be necessary for the search to review the prosecution history of a patent application and/or the history of the assignment records. In some systems, this level of review may require too much data and/or too complex a search. In these systems, the search may simply select the assignee identified on the patent application cover sheet, in the published patent application, or on the face of the issued patent, or the assignee that is identified on the first of these to be created.

In addition to identifying the companies to whom the individual transferred his or her intellectual property ownership interests, the Search Patent Ownership Data step 1705 may include various dates as part of the results of the search. For example, the search may report on the filing dates of the applications and/or the dates on which the individual transferred his or her ownership interests. These dates may be indicative of time periods during which the individual worked for the companies to whom his or her interests were transferred.

As indicated, the specified individual is likely to have worked for the companies to whom the individual transferred his or her patent and/or patent application ownership interests. The identity of these owners may be compiled into an employment history report, as reflected by a Generate Report step 1707.

FIG. 18 illustrates a report identifying at least portions of the likely employment history of a specified individual. This report may be generated by the process illustrated in FIG. 17, the computer system illustrated in FIG. 1, and/or by any other process or computer system. Similarly, the process illustrated in FIG. 17 and/or the computer system illustrated in FIG. 1 may be used to generate any other type of employment history report.

As illustrated in FIG. 18, the report may list the companies for whom the identified individual likely worked. The report may list the filing dates of the first and last patent applications that were transferred to each company by the specified individual. These dates may be indicative of a time period during which the individual worked for each company.

The report may in addition or instead list the first and last dates on which the individual transferred his or her interests to the company. These dates may also be indicative of a time period during which the individual worked for each company.

In some cases, the report may use a mixture of filing and assignment dates. For example, the report may use the earlier of the earliest filing or assignment dates as an indication of the earliest known date when the individual may have been working for the company. Similarly, the report may use the latest filing date as an indication of when the individual may have last been known to have worked for the company, even thought the assignment date for that last application may be later. This may be done based on the assumption that employees sometimes do not assign their rights to companies until after their employment terminates.

As with the report of likely competitors illustrated in FIG. 16, variations in the names of companies that result from the Search Patent Ownership Data step 1705 may be merged and consolidated, such as variations due to misspellings and the use of acronyms. The information that is reported may be arranged in chronological order, based on any of the types of dates that are discussed above, as well as based on any other criteria.

In some cases, a specified individual may only be named in a single patent application of a particular company. In this case, the earliest and latest dates that may be listed may be the same date, as illustrated by the last entry in the table in FIG. 18.

In other cases, there may be an overlap between the earliest and latest dates that may be associated with different companies. In this case, the report may resolve the overlap in any manner, such as by listing the company with the earliest date first.

Although the list in FIG. 18 is sorted from oldest to most recent, the list may be sorted in the reverse order.

The report may indicate in some way that the individual is likely to have worked for the listed owners. This may be done with textual information, such as by the header illustrated in FIG. 18. It may in addition or instead be done with symbols or through any other language or means.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently.

The phrase “means for” when used in a claim embraces the corresponding structures and materials that have been described and their equivalents. Similarly, the phrase “step for” when used in a claim embraces the corresponding acts that have been described and their equivalents. The absence of these phrases means that the claim is not limited to any of the corresponding structures, materials, or acts or to their equivalents.

Nothing that has been stated or illustrated is intended to cause a dedication of any component, step, feature, object, benefit, advantage, or equivalent to the public, regardless of whether it is recited in the claims.

In short, the scope of protection is limited solely by the claims that now follow. That scope is intended to be as broad as is reasonably consistent with the language that is used in the claims and to encompass all structural and functional equivalents.

We claim:

1. A computer system configured with software that performs an automated process for identifying likely competitors of a specified entity that includes:
receiving information indicative of the identity of the specified entity;
searching patent ownership data for patents and/or patent applications that are owned by the specified entity, the patent ownership data being indicative of the identity of owners of patents and/or patent applications;
searching patent citation data for patents and/or patent applications that are cited by and/or that cite to the patents and/or patent applications that are owned by the specified entity, the patent citation data being indicative of the identity of patents and/or patent applications that cite to or are cited by other patents and/or patent applications;
searching the patent ownership data for the owners of the cited and/or citing patents and/or patent applications; and
generating a report identifying the owners of the cited and/or citing patents and/or patent applications.

2. The computer system of claim 1 wherein the searching the patent citation data includes searching for patents and/or patent applications that are cited by the patents and/or patent applications that are owned by the specified entity.

3. The computer system of claim 1 wherein the searching the patent citation data includes searching for patents and/or patent applications that cite to the patents and/or patent applications that are owned by the specified entity.

4. The computer system of claim 1 wherein the patent citation data includes issued patents and the searching for cited and/or citing patents and/or patent applications includes searching the References Cited section of the issued patents.

5. The computer system of claim 1 wherein the patent citation data includes Information Disclosure Statements and the searching for cited and/or citing patents and/or patent applications includes searching the Information Disclosure Statements.

6. The computer system of claim 1 wherein the patent citation data includes the specifications of patents and/or patent applications and the searching for cited and/or citing patents and/or patent applications includes searching the specifications of the patents and/or patent applications.

7. The computer system of claim 1 wherein the report indicates in some way that the owners of the cited and/or citing patents and/or patent applications are likely competitors of the specified entity.

8. The computer system of claim 1 wherein the report provides information relating to the number of cited and/or citing patents and/or patent applications that are owned by each owner.

9. The computer system of claim 8 wherein the information relating to the numbers includes presenting the owners in a sequence that is based on the numbers.

10. The computer system of claim 8 wherein the information relating to the numbers includes information indicative of the relative differences between the numbers.

11. The computer system of claim 1 wherein the report excludes owners that own less than a threshold number of the cited and/or citing patents and/or patent applications.

12. The computer system of claim 1 wherein the report excludes owners that own less of the cited and/or citing patents and/or patent applications than other owners.

13. The computer system of claim 1 wherein the searching the patent ownership data for patents and/or patent applications that are owned by the specified entity includes searching the patent ownership data for patents and/or patent applications that are owned by subsidiaries of the specified company.

14. The computer system of claim 1 wherein either of the searching patent ownership data includes searching for inexact matches to the specified entity.

15. The computer system of claim 1 wherein either of the searching patent ownership data includes searching for alternate names for the specified entity.

16. The computer system of claim 15 wherein the information indicative of the specified entity is the ticker symbol of the specified entity and wherein an alternate name for at least one of the various entities includes the ticker symbol of the entity.

17. The computer system of claim 1 wherein the patent ownership data includes patents and/or patent applications.

18. The computer system of claim 1 wherein the patent ownership data includes assignment records for patents and/or patent applications.

19. The computer system of claim 1 wherein:
the patent ownership data includes patents and/or patent applications and assignment records for patents and/or published applications; and
the patents and/or patent applications that are owned by the specified entity exclude patents and/or patent applications that are indicated in the patents and/or published applications as being owned by the specified entity, but that are indicated in the assignment records as no longer being owned by the specified entity.

20. The computer system of claim 19 wherein the owner of a cited and/or citing patent and/or patent application is designated as the owner indicated in the assignment records when different from the owner designated in the patents and/or patent applications.

21. The computer system of claim 1 wherein the report identifies owners of the cited and/or citing patents and/or patent applications that have alternate names as the same owner.

22. The computer system of claim 1 wherein the report identifies misspelled versions of owners of the cited and/or citing patents and/or patent applications as the same owner.

23. A computer system configured with software that performs an automated process for identifying likely competitors of a specified entity that includes generating a report identifying the owners of patents and/or patent applications that cite to and/or are cited by patents and/or patent applications that are owned by the specified entity.

24. Computer-readable media containing computer-readable instructions that perform an automated process for identifying likely competitors of a specified entity that includes generating a report identifying the owners of patents and/or patent applications that cite to and/or are cited by patents and/or patent applications that are owned by the specified entity.

25. An automated process for identifying likely competitors of a specified entity comprising generating a report identifying the owners of patents and/or patent applications that cite to and/or are cited by patents and/or patent applications that are owned by the specified entity.
